(19) United States
(12) Patent Application Publication
(10) Pub. No.: US 2026/0005463 A1
(43) Pub. Date: Jan. 1, 2026

(54) Connector Assembly and Plate-End Connector and Cable-End Connector Thereof

(71) Applicants: Tarng Yu Enterprise co., ltd., New Taipei City (TW); Dongguan Tarng Yu Electronics Co., Ltd., Dongguan City (CN)

(72) Inventors: TSUNG-CHI CHEN, New Taipei City (TW); MU-JUNG HUANG, New Taipei City (TW)

(21) Appl. No.: 19/237,981

(22) Filed: Jun. 13, 2025

(30) Foreign Application Priority Data
Jun. 28, 2024 (TW) 113124445

(51) Int. Cl. H01R 13/502

(52) U.S. Cl. CPC H01R 13/502

(57) ABSTRACT

A miniaturizable connector assembly and plate-end connector and cable-end connector thereof. The cable-end connector is configured to be joined with the plate-end connector, and the plate-end connector comprises a plate-end insulation core and a plate-end sliding cover. The plate-end sliding cover is configured to prevent the cable-end connector from leaving the plate-end core joining space. In this way, it can effectively prevent the cable-end connector of the miniaturized connector assembly from easily detaching from the mated plate-end connector when the electronic product is subjected to external impact

### CROSS-REFERENCE TO RELATED APPLICATIONS

This application claims the priority of Republic of China Patent Application No. 113124445 filed on Jun. 28, 2024, in the State Intellectual Property Office of the R.O.C., the disclosure of which is incorporated herein by reference.

### BACKGROUND OF THE INVENTION

### Field of the Invention

The present application relates to the technical field of electronic devices, and more specifically, to a miniaturizable connector assembly and plate-end connector and cable-end connector thereof.

### Descriptions of the Related Art

Conventionally, in electronic products, a connector assembly is often used to transmit electrical signals or power signals. Generally, the connector assembly comprises a cable-end connector and a plate-end connector, wherein the cable-end connector is capable of joining with the plate-end connector, and the cable-end connector is prevented from detaching from the plate-end connector through the frictional force generated by contact with the plate-end connector.

However, as electronic products develop towards thinner and more compact designs, the internal space of electronic products becomes limited, resulting in the continuous demand for the miniaturization of the connector assembly. Consequently, the sizes of the cable-end connector and the plate-end connector must also be reduced. This often leads to a problem where the cable-end connector lacks sufficient contact area with the plate-end connector, causing insufficient frictional force. As a result, the cable-end connector can easily detach from the mated plate-end connector under external impact, which affects the normal operation of the electronic product and may even cause damage to the electronic product.

In view of this, how to solve the various problems of the miniaturized connector assembly in electronic products, specifically the issue of the cable-end connector easily detaching from the mated plate-end connector under external impact, has become an urgent issue for those skilled in the art.

### SUMMARY OF THE INVENTION

In view of the drawbacks of the prior art mentioned above, the present application provides a plate-end connector configured to engage with a cable-end connector, the plate-end connector comprising: a plate-end conductive terminal comprising a plate-end terminal joining structure; a plate-end insulation core comprising a plate-end core joining guiding structure, a plate-end core joining passage, a plat e-end core joining space, a plate-end core sliding slot, and a plate-end core open joining passage wall, wherein, the plate-end insulation core is configured to mate with the plate-end conductive terminal to position the plate-end terminal joining structure within the plate-end core joining space; two ends of the plate-end core sliding slot respectively comprise a plate-end core sliding slot open joining passage end and a plate-end core sliding slot closed joining passage end; the plate-end core open joining passage wall is adjacent to the plate-end core sliding slot open joining passage end; and the plate-end core joining passage is extended to the plate-end core joining space; and comprising a plate-end sliding cover body and a plate-end sliding cover guiding structure, wherein the plate-end sliding cover guiding structure is configured to enter the plate-end core sliding slot and to be guided by the plate-end core sliding slot to slide to the plate-end core sliding slot open joining passage end or the plate-end core sliding slot closed joining passage end, so as to allow the plate-end sliding cover body to slide relative to the plate-end insulation core to a plate-end sliding cover open joining passage position or a plate-end sliding cover closed joining passage position, wherein, when the plate-end sliding cover body slides to the plate-end sliding cover open joining passage position, the plate-end sliding cover body leaves the plate-end core joining passage to open the plate-end core joining passage, allowing the plate-end core joining guiding structure to guide the cable-end connector through the plate-end core joining passage into the plate-end core joining space to be joined with the plate-end terminal joining structure, and the plate-end sliding cover guiding structure abuts the plate-end core open joining passage wall at the plate-end core sliding slot open joining passage end, such that the plate-end sliding cover guiding structure is prevented from leaving the plate-end core sliding slot by the plate-end core open joining passage wall; and wherein, when the plate-end sliding cover body slides to the plate-end sliding cover closed joining passage position, the plate-end sliding cover body enters the plate-end core joining passage, thereby preventing the cable-end connector from entering or leaving the plate-end core joining space through the plate-end core joining passage.

Preferably, the plate-end connector said above, wherein the plate-end insulation core further comprises a plate-end core closed joining passage wall adjacent to the plate-end core sliding slot closed joining passage end, wherein, when the plate-end sliding cover body slides to the plate-end sliding cover closed joining passage position, the plate-end sliding cover is allowed to abut the plate-end core closed joining passage wall at the plate-end core sliding slot closed joining passage end, such that the plate-end sliding cover guiding structure is prevented from leaving the plate-end core sliding slot by the plate-end core closed joining passage wall.

Preferably, the plate-end connector said above, wherein the plate-end sliding cover further comprises a plate-end sliding cover guiding elastic arm connected to the plate-end sliding cover guiding structure, and the plate-end sliding cover guiding elastic arm is elastically deformable to allow the plate-end sliding cover guiding structure to enter the plate-end core sliding slot.

Preferably, the plate-end connector said above, wherein the plate-end insulation core further comprises a plate-end core interference guiding structure and a plate-end core joining interference structure, which are positioned in the plate-end core joining passage, wherein, when the cable-end connector is joined with the plate-end terminal joining structure, the plate-end core interference guiding structure guides the plate-end core joining interference structure to interfere with the cable-end connector, thereby preventing the cable-end connector from leaving the plate-end core joining space through the plate-end core joining passage.

Preferably, the plate-end connector said above, wherein the plate-end core interference guiding structure and the plate-end core joining interference structure are connectable to form a hook-shaped structure.

Preferably, the plate-end connector said above, wherein the plate-end insulation core further comprises a plate-end core open joining passage positioning structure, and the plate-end sliding cover further comprises a plate-end sliding cover positioning structure configured to engage with the plate-end core open joining passage positioning structure so as to position the plate-end sliding cover body at the plate-end sliding cover open joining passage position.

Preferably, the plate-end connector said above, wherein the plate-end insulation core further comprises a plate-end core closed joining passage positioning structure configured to engage with the plate-end sliding cover positioning structure so as to position the plate-end sliding cover body at the plate-end sliding cover closed joining passage position.

Preferably, the plate-end connector said above, wherein when the plate-end sliding cover body slides to the plate-end sliding cover closed joining passage position, the plate-end sliding cover positioning structure abuts the cable-end connector, thereby preventing the cable-end connector from entering or leaving the plate-end core joining space through the plate-end core joining passage.

Additionally, the present application provides a cable-end connector configured to engage with a conductive cable material and the plate-end connector of claim 1, the cable-end connector comprising: a cable-end insulation core comprising a cable-end core plate-end side and a cable-end core sliding cover side respectively at two sides thereof; the cable-end insulation core comprising a cable-end core joining guiding structure, a cable-end core joining passage, a cable-end core joining space, a cable-end core configuration structure, a cable-end core wiring space, and a cable-end core sliding guiding structure, wherein, the cable-end core wiring space, the cable-end core joining guiding structure, the cable-end core joining passage, the cable-end core joining space, and the cable-end core sliding guiding structure are positioned on the cable-end core plate-end side; the cable-end core sliding guiding structure is positioned on the cable-end core sliding cover side; and the cable-end core joining passage is extended to the cable-end core joining space; and a cable-end conductive terminal comprising a plurality of cable-end terminal joining structures, a cable-end terminal configuration structure, and a cable-end terminal wiring structure; wherein, the cable-end terminal wiring structure is configured to provide electrical connection to the conductive cable material; the cable-end terminal configuration structure is configured to engage with the cable-end core configuration structure, so as to assemble the cable-end conductive terminal in the cable-end insulation core and position the cable-end terminal wiring structure and the plurality of cable-end terminal joining structures respectively in the cable-end core wiring space and in the cable-end core joining space; the cable-end core joining guiding structure is configured to guide the plate-end terminal joining structure through the cable-end core joining passage into the cable-end core joining space to be joined with the plurality of cable-end terminal joining structures respectively; the plurality of cable-end terminal joining structures are located at different positions, allowing the cable-end conductive terminal to be joined with the plate-end terminal joining structure at multiple positions; and the cable-end core sliding guiding structure is configured to guide the plate-end sliding cover body to slide relative to the plate-end insulation core.

Preferably, the cable-end connector said above, wherein the cable-end insulation core is embedded in the plate-end insulation core, such that the cable-end core sliding guiding structure is positioned below the plate-end sliding cover body, thereby preventing the cable-end insulation core from interfering with the sliding of the plate-end sliding cover body.

Preferably, the cable-end connector said above, wherein the cable-end insulation core comprises a cable-end core sliding surface located at the cable-end core sliding cover side, and the cable-end core sliding guiding structure is positioned on the cable-end core sliding surface.

Preferably, the cable-end connector said above, wherein when the plate-end sliding cover body slides to the plate-end sliding cover closed joining passage position, the plate-end sliding cover abuts the cable-end insulation core, thereby preventing the cable-end insulation core from leaving the plate-end core joining space through the plate-end core joining passage.

Preferably, the cable-end connector said above, wherein the cable-end insulation core further comprises a cable-end core interference guiding structure and a cable-end core joining interference structure, and when the plate-end terminal joining structure is joined with the plurality of cable-end terminal joining structures respectively, the cable-end core interference guiding structure guides the cable-end core joining interference structure to interfere with the plate-end insulation core, thereby preventing the cable-end insulation core from leaving the plate-end core joining space through the plate-end core joining passage.

Preferably, the cable-end connector said above, wherein the cable-end core interference guiding structure and the cable-end core joining interference structure are connectable to form a hook-shaped structure.

Additionally, the present application provides a connector assembly comprising: a cable-end connector comprising: a cable-end conductive terminal comprising a plurality of cable-end terminal joining structures; and a cable-end insulation core comprising a cable-end core joining guiding structure, a cable-end core joining passage, and a cable-end core joining space, wherein the cable-end insulation core is configured to assemble with the cable-end conductive terminal to position the plurality of terminal joining structures within the core joining space; and the cable-end core joining passage is extended to the cable-end core joining space; and a plate-end connector comprising: a plate-end conductive terminal comprising a plate-end terminal joining structure; a plate-end insulation core comprising a plate-end core joining guiding structure, a plate-end core joining passage, a plate-end core joining space, a plate-end core sliding slot, and a plate-end core open joining passage wall, wherein, the plate-end insulation core is configured to mate with the plate-end conductive terminal to position the plate-end terminal joining structure in the plate-end core joining space; two ends of the plate-end core sliding slot respectively comprises a plate-end core sliding slot open joining passage end and a plate-end core sliding slot closed joining passage end; the plate-end core open joining passage wall is adjacent to the plate-end core sliding slot open joining passage end; and the plate-end core joining passage is extended to the plate-end core joining space; and comprising a plate-end sliding cover body and a plate-end sliding cover guiding structure, wherein the plate-end sliding cover guiding structure is configured to enter the plate-end core sliding slot and to be guided by the plate-end core sliding slot to slide to the plate-end core sliding slot open joining passage end or the plate-end core sliding slot closed joining passage end, so as to allow the plate-end sliding cover body to slide relative to the plate-end insulation core to a plate-end sliding cover open joining passage position or a plate-end sliding cover closed joining passage position; wherein, when the plate-end sliding cover body slides to the plate-end sliding cover open joining passage position, the plate-end sliding cover body leaves the plate-end core joining passage to open the plate-end core joining passage, allowing the plate-end core joining guiding structure to guide the cable-end connector through the plate-end core joining passage into the plate-end core joining space, and the cable-end core joining guiding structure guides the plate-end terminal joining structure through the cable-end core joining passage into the cable-end core joining space to be joined with the plurality of cable-end terminal joining structures respectively; the plurality of cable-end terminal joining structures are located at different positions, allowing the cable-end conductive terminal to be joined with the plate-end terminal joining structure at multiple positions; and the plate-end sliding cover guiding structure is configured to abut the plate-end core open joining passage wall at the plate-end core sliding slot open joining passage end, such that the plate-end sliding cover guiding structure is prevented from leaving the plate-end core sliding slot by the plate-end core open joining passage wall; and when the plate-end sliding cover body slides to the plate-end sliding cover closed joining passage position, the plate-end sliding cover body enters the plate-end core joining passage, thereby preventing the cable-end connector from entering or leaving the plate-end core joining space through the plate-end core joining passage.

Compared to the prior art, the present application provides a miniaturizable connector assembly and plate-end connector and cable-end connector thereof. The cable-end connector is configured to be joined with the plate-end connector, and the plate-end connector comprises a plate-end insulation core and a plate-end sliding cover. The plate-end insulation core comprises a plate-end core joining space, and the cable-end connector is configured to be joined with the plate-end connector. The plate-end sliding cover is configured to prevent the cable-end connector from leaving the plate-end core joining space. In this way, it can effectively prevent the cable-end connector of the miniaturized connector assembly from easily detaching from the mated plate-end connector when the electronic product is subjected to external impact, thereby ensuring that the signal transmission performance of the connector assembly meets expectations.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic view showing a first perspective of the connector assembly of the present application in one embodiment.

FIG. 2 is a three-dimensional schematic view showing a second perspective of the connector assembly of the present application in one embodiment.

FIG. 3 is a top view of the connector assembly of the present application in one embodiment.

FIG. 4 is a sectional view of the connector assembly shown in FIG. 3, taken along line AA.

FIG. 5 is a side view of the connector assembly of the present application in one embodiment.

FIG. 6 is a sectional view of the connector assembly shown in FIG. 5, taken along line BB.

FIG. 7 is a three-dimensional schematic view showing a first perspective of the connector assembly of the present application in one embodiment.

FIG. 8 is a three-dimensional schematic view showing a second perspective of the connector assembly of the present application in one embodiment.

FIG. 9 is a top view of the connector assembly of the present application in one embodiment.

FIG. 10 is a sectional view of the connector assembly shown in FIG. 9, taken along line A′A′.

FIG. 11 is a side view of the connector assembly of the present application in one embodiment.

FIG. 12 is a sectional view of the connector assembly shown in FIG. 11, taken along line B′B′.

FIG. 13 is a three-dimensional schematic view showing a first perspective of the connector assembly of the present application in one embodiment.

FIG. 14 is a three-dimensional schematic view showing a second perspective of the connector assembly of the present application in one embodiment.

FIG. 15 is a sectional view of the connector assembly shown in FIG. 9, taken along line A″A″.

FIG. 16 is a three-dimensional schematic view showing a first perspective of the cable-end connector of the present application in one embodiment.

FIG. 17 is a three-dimensional schematic view showing a second perspective of the cable-end connector of the present application in one embodiment.

FIG. 18 is a three-dimensional schematic view of the cable-end conductive terminal of the present application in one embodiment.

FIG. 19 is a front view of the cable-end connector of the present application in one embodiment.

FIG. 20 is a sectional view of the cable-end connector shown in FIG. 19, taken along line CC.

FIG. 21 is a sectional view of the cable-end connector shown in FIG. 19, taken along line C′C′.

FIG. 22 is a three-dimensional schematic view showing a first perspective of the plate-end connector of the present application in one embodiment.

FIG. 23 is a three-dimensional schematic view showing a second perspective of the plate-end connector of the present application in one embodiment.

### DETAILED DESCRIPTION OF THE PREFERRED EMBODIMENT

The following description illustrates the technical content of the present application by way of specific embodiments. Those skilled in the art may readily understand other advantages and effects of the present application based on the content disclosed herein. The present application may also be implemented or applied through other different specific embodiments. Various modifications and alterations to the details in this specification may be made from different perspectives and applications without departing from the spirit of the present application.

The above and other aspects, features, and advantages of the present application will be more clearly understood from the following description of embodiments in conjunction with the accompanying drawings.

The present application provides a connector assembly, and plate-end connector and cable-end connector thereof. The cable-end connector is configured to mate with the plate-end connector, and the plate-end connector comprises a plate-end sliding cover, which is capable of preventing the cable-end connector from detaching from the plate-end connector. In this way, it can effectively prevent the miniaturized connector assembly in electronic products from comprising the cable-end connector easily detach from the mated plate-end connector under external impact.

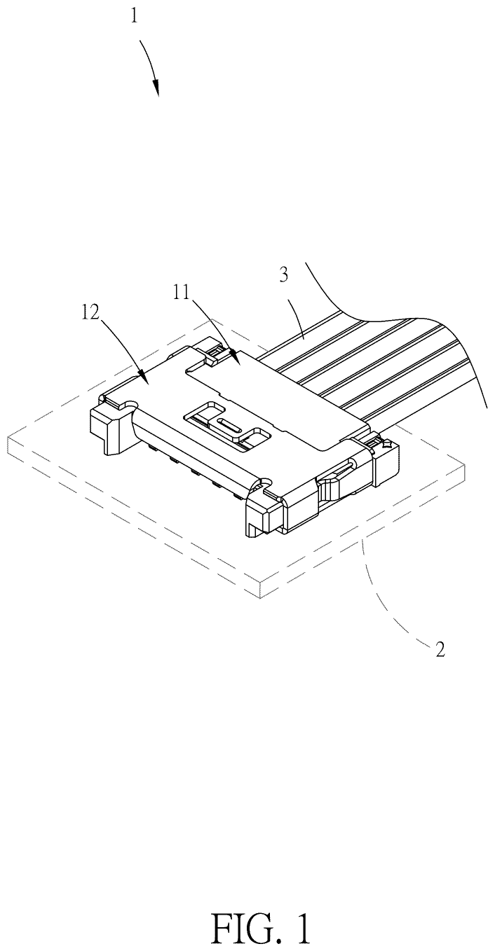

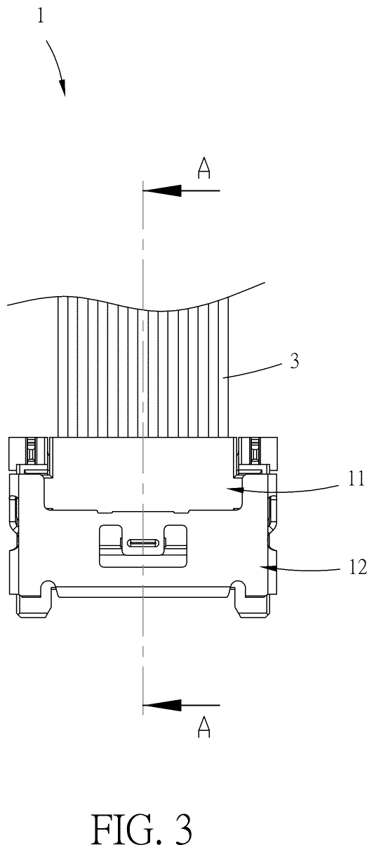

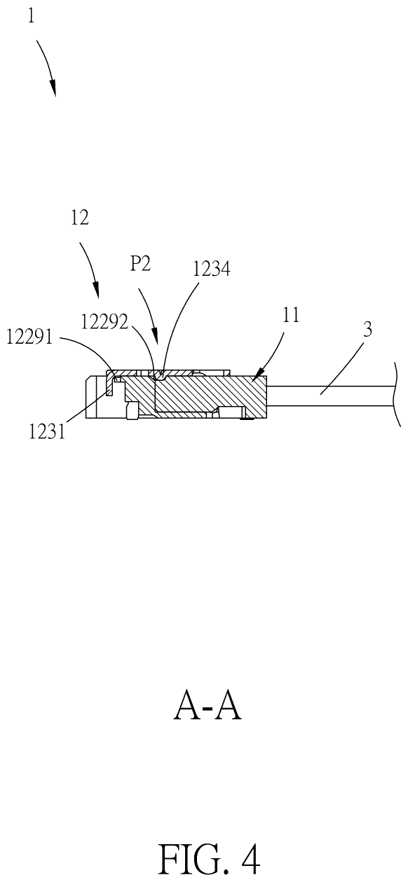

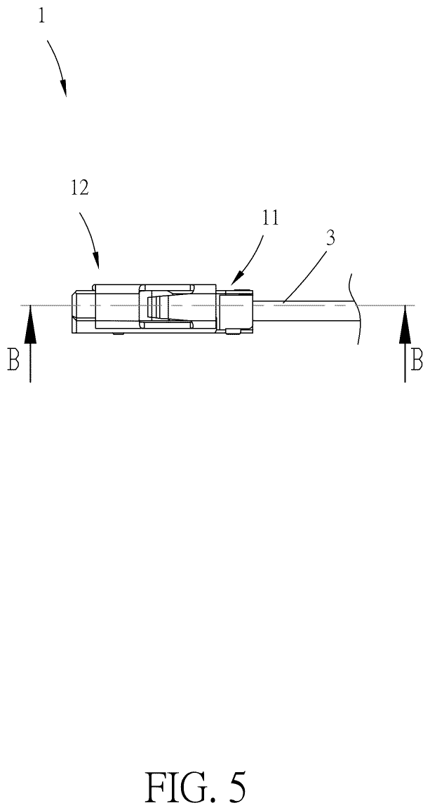

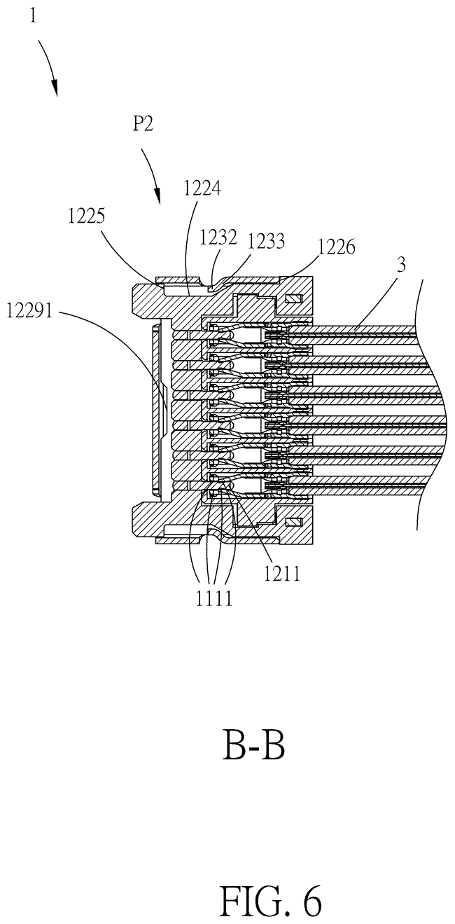

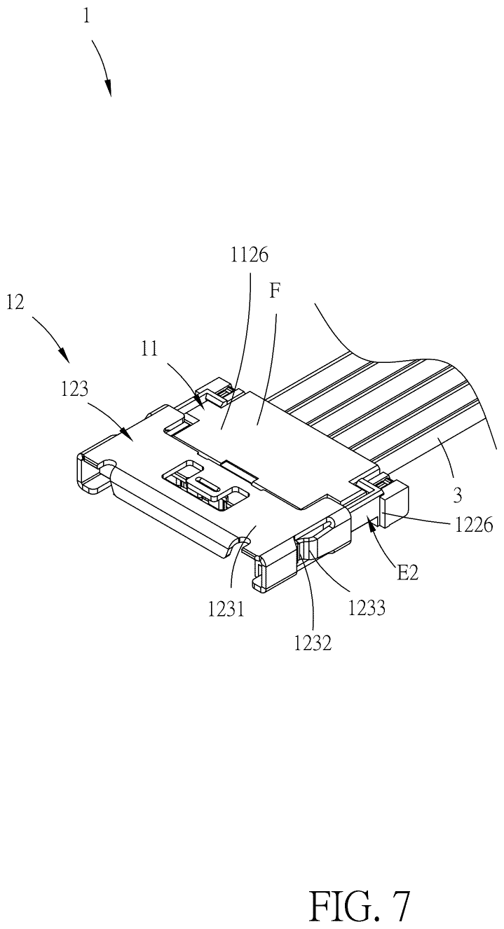

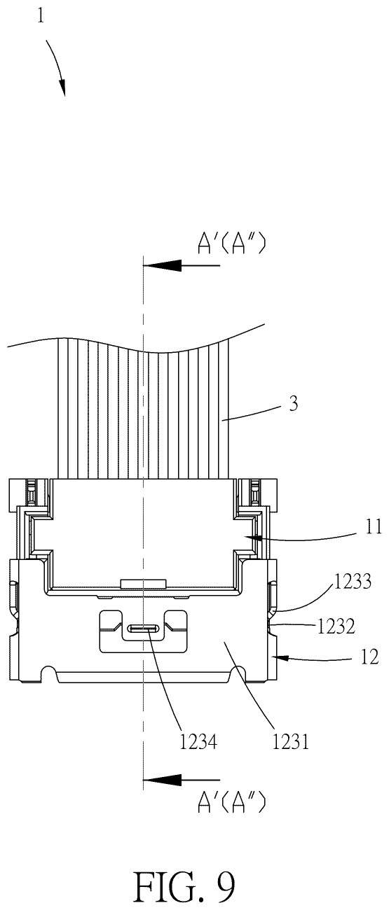

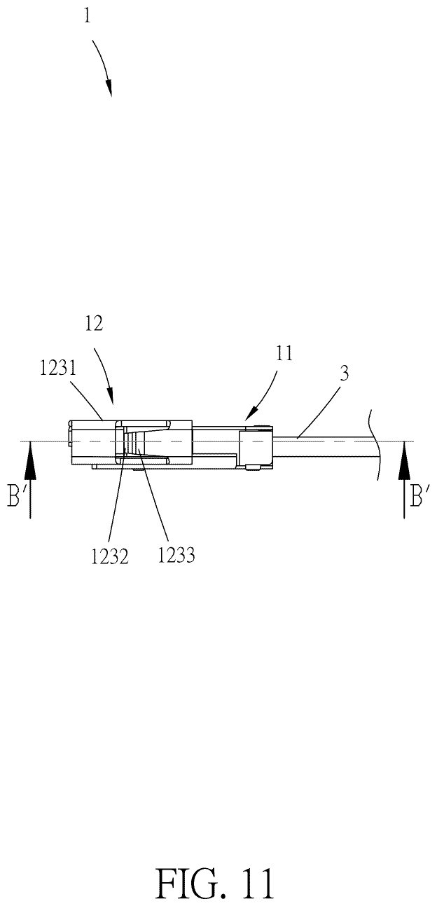

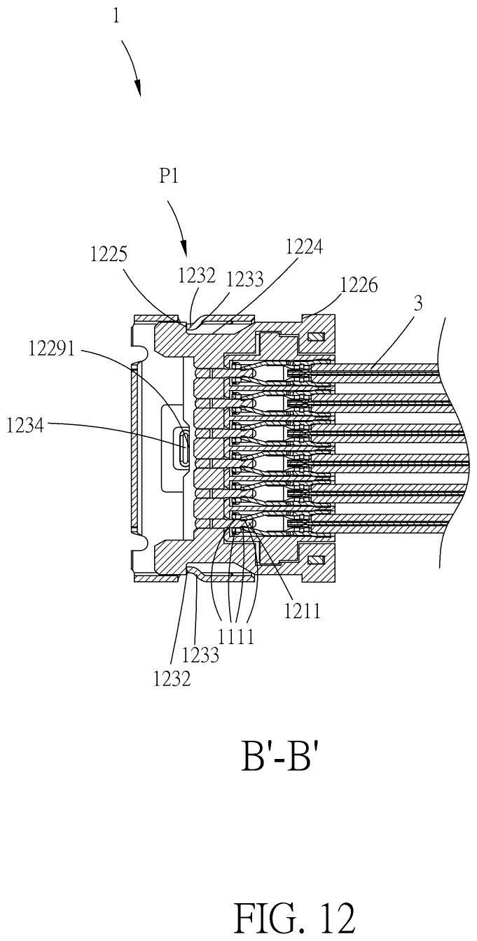

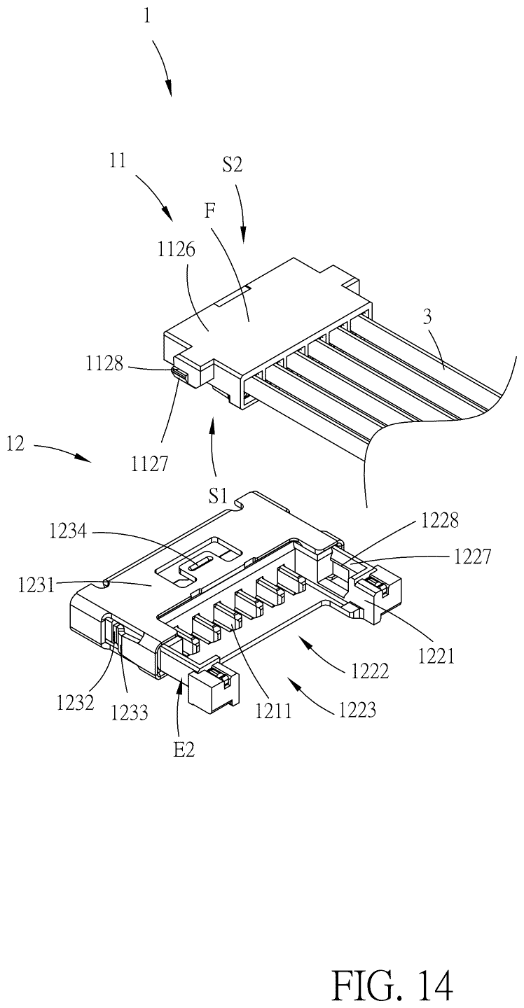

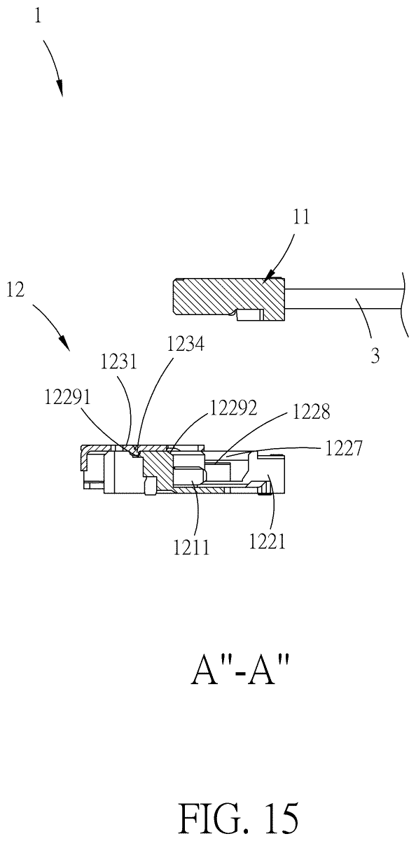

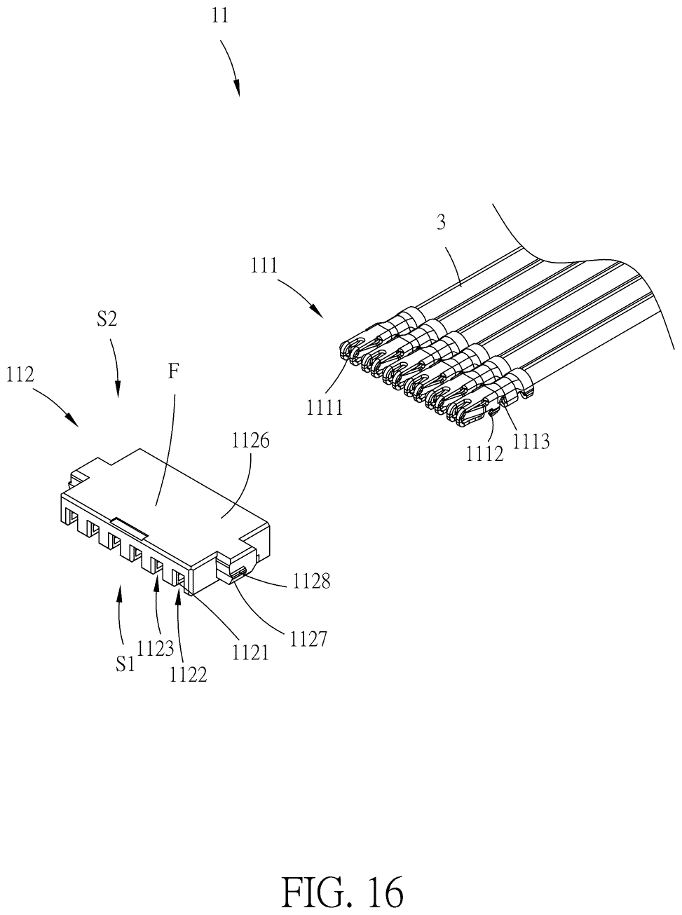

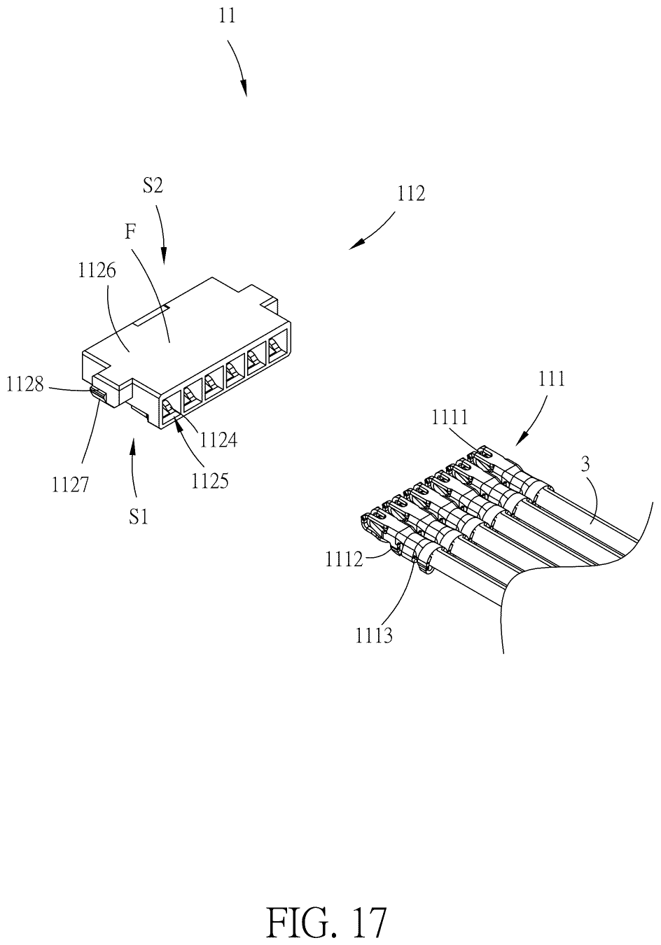

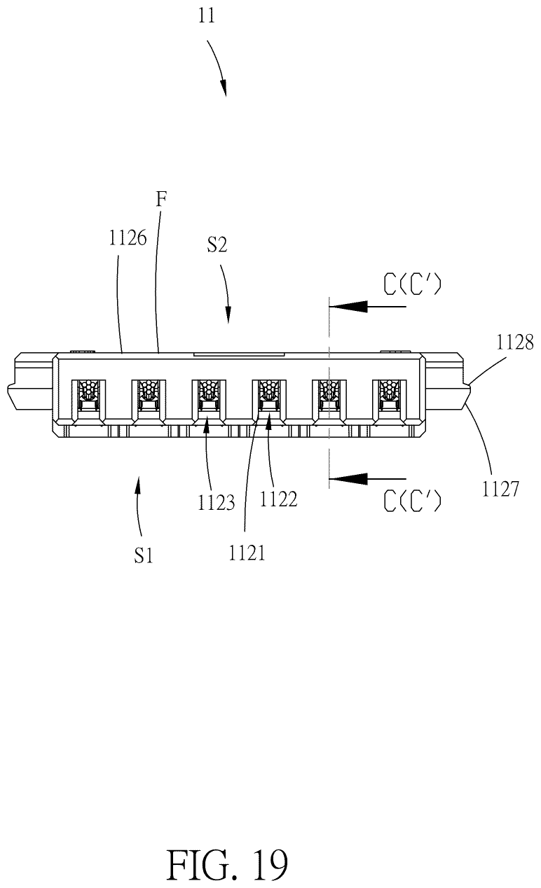

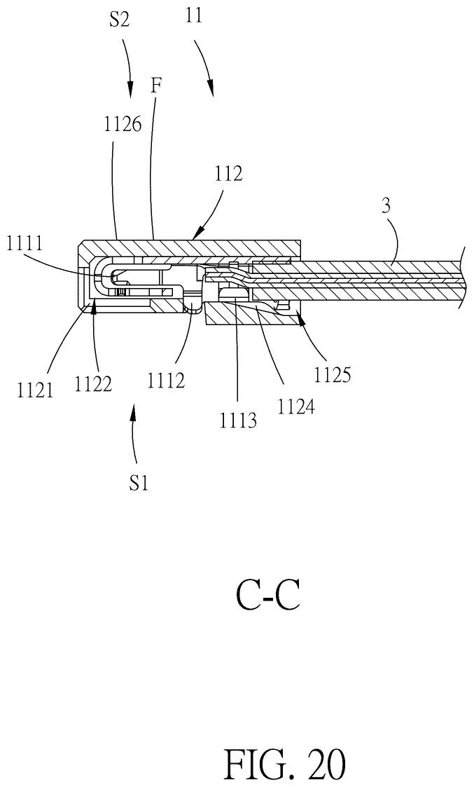

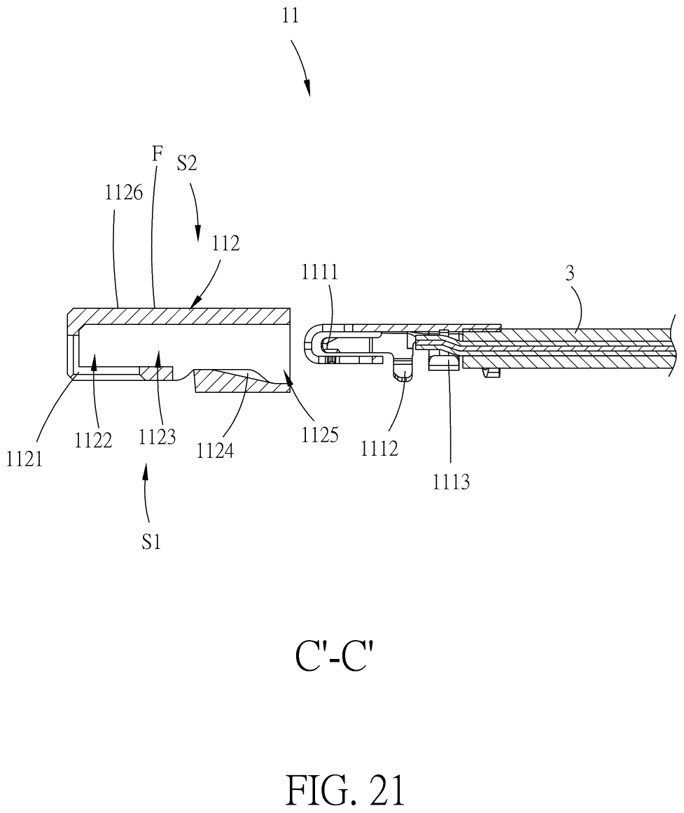

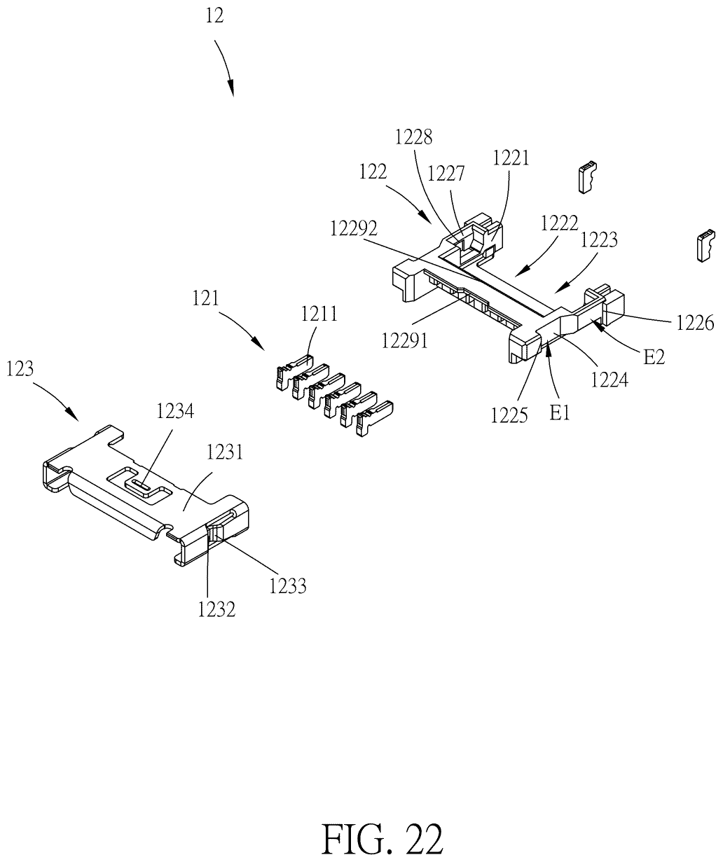

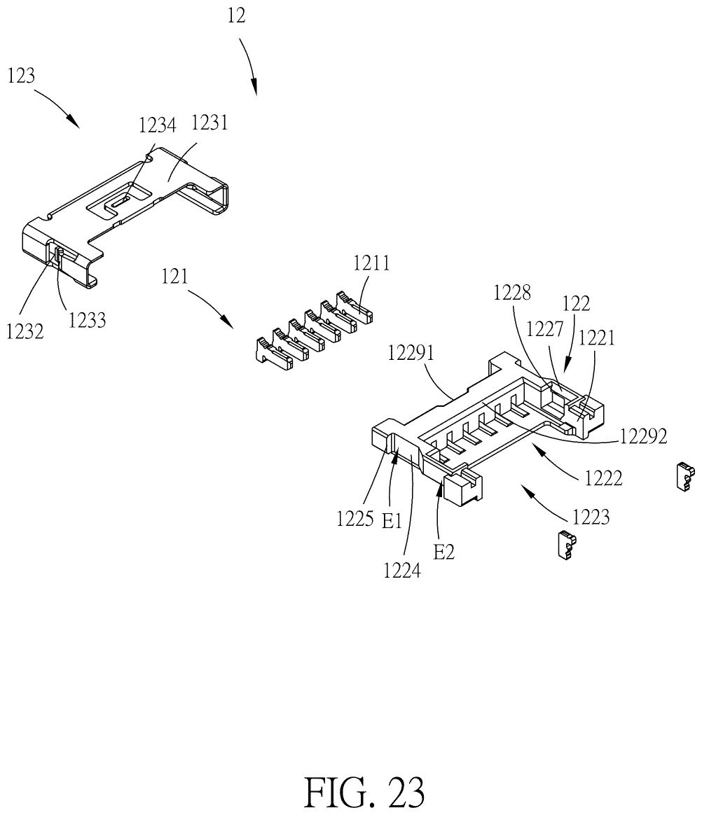

For a detailed description of the embodiments disclosed in the present application, please refer to FIGS. 1 to 23.

As shown in FIGS. 1 to 23, an embodiment of a connector assembly 1 is provided, comprising a cable-end connector 11 and a plate-end connector 12. The cable-end connector 11 is configured to be paired with a conductive cable material 3, and the plate-end connector 12 is configured to be paired with a conductive plate material 2. In the above embodiment, the cable-end connector 11 is capable of joining with the plate-end connector 12 to transmit electrical signals or power signals, enabling electrical connection between the conductive cable material 3 and the conductive plate material 2.

Regarding the cable-end connector 11, it comprises a cable-end conductive terminal 111 and a cable-end insulation core 112. The cable-end conductive terminal 111 comprises a plurality of cable-end terminal joining structures 1111, a cable-end terminal configuration structure 1112, and a cable-end terminal wiring structure 1113.

It should be noted that the cable-end terminal wiring structure 1113 can optionally be a crimping structure to provide electrical connection to the conductive cable material 3, thereby electrically connecting the cable-end conductive terminal 111 to the conductive cable material 3.

In the above embodiment, the two sides of the cable-end insulation core 112 can be respectively defined as a cable-end core plate-end side S1 and a cable-end core sliding cover side S2. The cable-end insulation core 112 comprises a cable-end core joining guiding structure 1121, a cable-end core joining passage 1122, a cable-end core joining space 1123, a cable-end core configuration structure 1124, a cable-end core wiring space 1125, a cable-end core sliding guiding structure 1126, a cable-end core interference guiding structure 1127, and a cable-end core joining interference structure 1128.

It should be noted that in the above embodiment, the cable-end core wiring space 1125, the cable-end core joining guiding structure 1121, the cable-end core joining passage 1122, the cable-end core joining space 1123, and the cable-end core sliding guiding structure 1126 are positioned on the cable-end core plate-end side S1, while the cable-end core sliding guiding structure 1126 is positioned on the cable-end core sliding cover side S2, allowing the height of the cable-end insulation core 112 to be reduced. Moreover, the cable-end core joining passage 1122 extends to the cable-end core joining space 1123, meaning that the cable-end core joining passage 1122 communicates with the cable-end core joining space 1123.

Optionally, the cable-end core interference guiding structure 1127 and the cable-end core joining interference structure 1128 can be connected to form a hook-shaped structure.

Furthermore, the cable-end terminal configuration structure 1112 is configured to engage with the cable-end core configuration structure 1124, enabling the cable-end conductive terminal 111 to be assembled into the cable-end insulation core 112, such that the cable-end terminal wiring structure 1113 is positioned in the cable-end core wiring space 1125, and the plurality of cable-end terminal joining structures 1111 are positioned in the cable-end core joining space 1123.

Regarding the plate-end connector 12, it comprises a plate-end conductive terminal 121, a plate-end insulation core 122, and a plate-end sliding cover 123. The plate-end conductive terminal 121 comprises a plate-end terminal joining structure 1211, which can optionally be in the form of a guillotine structure. The plate-end insulation core 122 comprises a plate-end core joining guiding structure 1221, a plate-end core joining passage 1222, a plate-end core joining space 1223, a plate-end core sliding slot 1224, a plate-end core open joining passage wall 1225, a plate-end core closed joining passage wall 1226, a plate-end core interference guiding structure 1227, a plate-end core joining interference structure 1228, a plate-end core open joining passage positioning structure 12291, and a plate-end core closed joining passage positioning structure 12292.

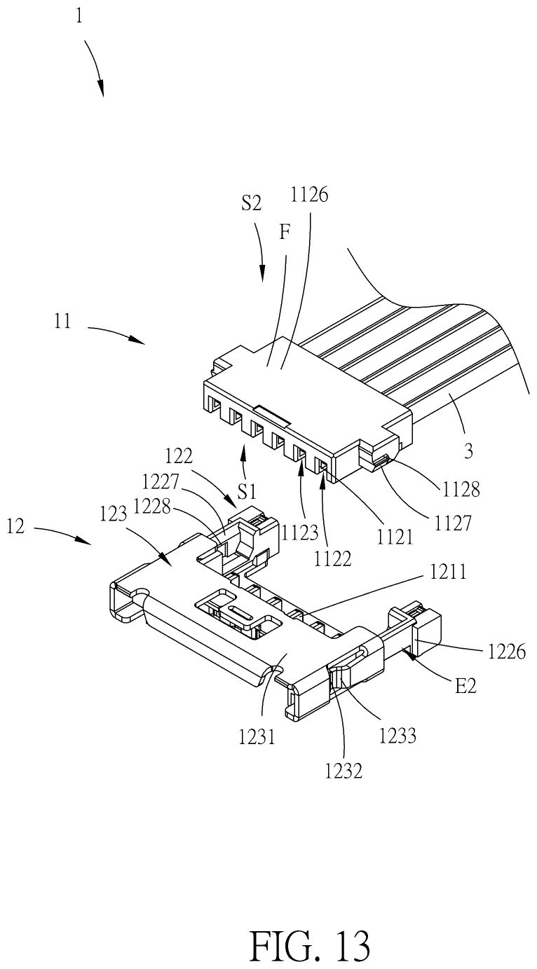

In the embodiment shown in FIGS. 13 to 15, 19, and 22 to 23, the plate-end core interference guiding structure 1227 and the plate-end core joining interference structure 1228 are located in the plate-end core joining passage 1222. Optionally, the plate-end core interference guiding structure 1227 and the plate-end core joining interference structure 1228 can be connected to form a hook-shaped structure.

It should be noted that the plate-end insulation core 122 is configured to be mated with the plate-end conductive terminal 121, positioning the plate-end terminal joining structure 1211 in the plate-end core joining space 1223. The two ends of the plate-end core sliding slot 1224 can be respectively defined as a plate-end core sliding slot open joining passage end E1 and a plate-end core sliding slot closed joining passage end E2. The plate-end core open joining passage wall 1225 is adjacent to the plate-end core sliding slot open joining passage end E1, while the plate-end core closed joining passage wall 1226 is adjacent to the plate-end core sliding slot closed joining passage end E2. The plate-end core joining passage 1222 extends to the plate-end core joining space 1223, meaning that the plate-end core joining passage 1222 communicates with the plate-end core joining space 1223.

The plate-end sliding cover 123 comprises a plate-end sliding cover body 1231, a plate-end sliding cover guiding structure 1232, a plate-end sliding cover guiding elastic arm 1233, and a plate-end sliding cover positioning structure 1234. The plate-end sliding cover guiding elastic arm 1233 is connected to the plate-end sliding cover guiding structure 1232. It should be noted that the plate-end sliding cover guiding elastic arm 1233 is elastically deformable, allowing the plate-end sliding cover guiding structure 1232 to enter the plate-end core sliding slot 1224. This enables the plate-end sliding cover guiding structure 1232 to be guided by the plate-end core sliding slot 1224, sliding to the plate-end core sliding slot open joining passage end E1 or the plate-end core sliding slot closed joining passage end E2, causing the plate-end sliding cover body 1231 to slide relative to the plate-end insulation core 122 to a plate-end sliding cover open joining passage position P1 or a plate-end sliding cover closed joining passage position P2.

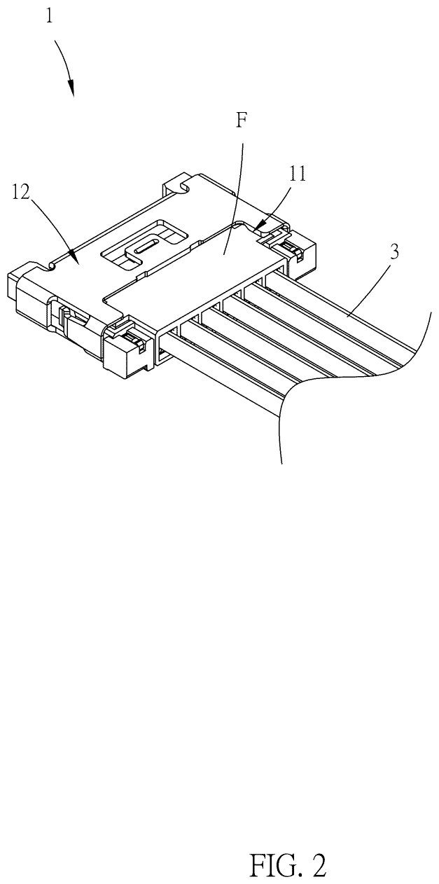

Additionally, regarding the sliding of the plate-end sliding cover body 1231, the cable-end core sliding guiding structure 1126 is capable of guiding the plate-end sliding cover body 1231 to slide relative to the plate-end insulation core 122. In the embodiments shown in FIGS. 2, 7 to 8, 13 to 14, 16 to 17, and 19 to 21, the cable-end insulation core 112 comprises a cable-end core sliding surface F. The cable-end core sliding surface F is located on the cable-end core sliding cover side S2, and the cable-end core sliding guiding structure 1126 is located on the cable-end core sliding surface F. Therefore, the cable-end insulation core 112 can be embedded into the plate-end insulation core 122, positioning the cable-end core joining guiding structure 1121 (or the cable-end insulation core 112) lower than the plate-end sliding cover body 1231. This prevents the cable-end insulation core 112 from interfering with the sliding of the plate-end sliding cover body 1231, thereby reducing the overall height of the connector assembly 1, which facilitates the miniaturization of the connector assembly 1.

In the above embodiment, when the plate-end sliding cover body 1231 slides to the plate-end sliding cover open joining passage position P1, the plate-end sliding cover body 1231 leaves the plate-end core joining passage 1222, opening the plate-end core joining passage 1222. This allows the plate-end core joining guiding structure 1221 to guide the cable-end connector 11 (or the cable-end insulation core 112) through the plate-end core joining passage 1222 into the plate-end core joining space 1223. Moreover, the cable-end core joining guiding structure 1121 can guide the plate-end terminal joining structure 1211 through the cable-end core joining passage 1122 into the plate-end core joining space 1223 to respectively mate with the plurality of cable-end terminal joining structures 1111.

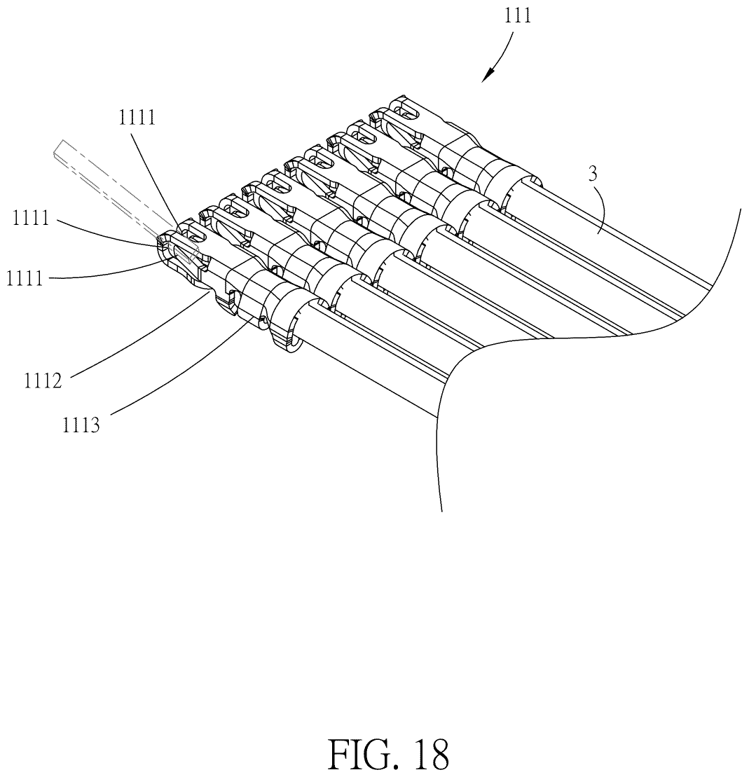

Additionally, in the embodiment shown in FIG. 18, the positions of the plurality of cable-end terminal joining structures 1111 are different, allowing the cable-end conductive terminal 111 to join the plate-end terminal joining structure 1211 at multiple positions. This enables the cable-end conductive terminal 111 to make multiple contact points with the plate-end conductive terminal 121, ensuring the electrical connection between the cable-end conductive terminal 111 and the plate-end conductive terminal 121.

It should be noted that when the plate-end terminal joining structure 1211 respectively mates with the plurality of cable-end terminal joining structures 1111, the cable-end core interference guiding structure 1127 guides the cable-end core joining interference structure 1128 to interfere with the plate-end insulation core 122. This interference prevents the cable-end insulation core 112 from leaving the plate-end core joining space 1223 through the plate-end core joining passage 1222, effectively preventing the cable-end connector 11 from easily detaching from the plate-end insulation core 122 and ensuring the joining relationship between the plate-end terminal joining structure 1211 and the plurality of cable-end terminal joining structures 1111.

Accordingly, when the cable-end connector 11 mates with the plate-end terminal joining structure 1211, the plate-end core interference guiding structure 1227 guides the plate-end core joining interference structure 1228 to interfere with the cable-end connector 11. This interference prevents the cable-end connector 11 from leaving the plate-end core joining space 1223 through the plate-end core joining passage 1222, effectively preventing the cable-end connector 11 from easily detaching from the plate-end insulation core 122 and ensuring the joining relationship between the cable-end connector 11 and the plate-end terminal joining structure 1211.

In the above embodiment, when the plate-end sliding cover body 1231 slides to the plate-end sliding cover open joining passage position P1, the plate-end sliding cover guiding structure 1232 can abut the plate-end core open joining passage wall 1225 at the plate-end core sliding slot open joining passage end E1. This prevents the plate-end sliding cover guiding structure 1232 from leaving the plate-end core sliding slot 1224, effectively preventing the plate-end sliding cover 123 from easily detaching from the plate-end insulation core 122.

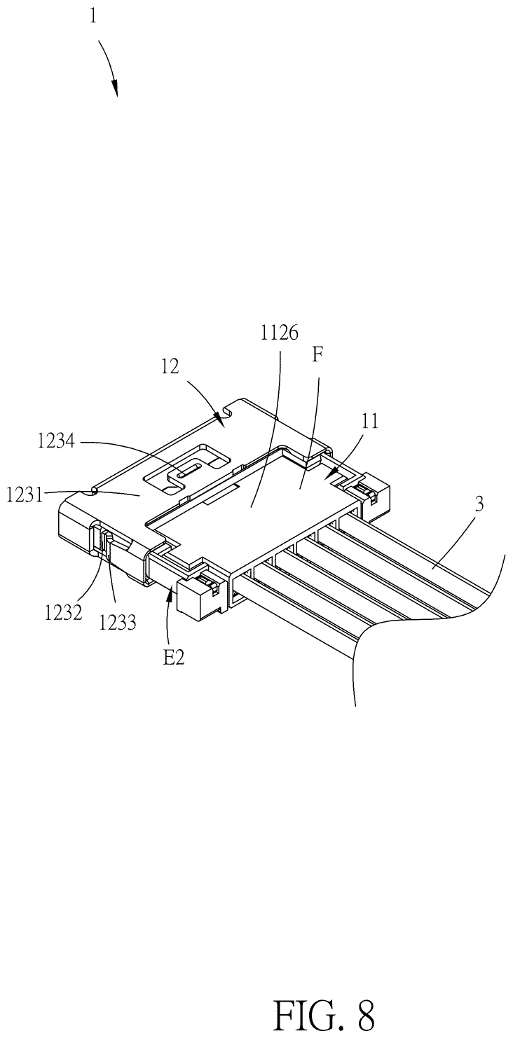

In the embodiment shown in FIG. 8, the plate-end sliding cover positioning structure 1234 is a protruding structure that can engage with the plate-end core open joining passage positioning structure 12291, thereby positioning the plate-end sliding cover body 1231 at the plate-end sliding cover open joining passage position P1. This effectively prevents the plate-end sliding cover body 1231 from easily leaving the plate-end sliding cover open joining passage position P1. However, the present disclosure is not limited to this; the plate-end sliding cover positioning structure 1234 can be of other structural forms and still be configured to engage with the plate-end core open joining passage positioning structure 12291.

In the above embodiment, when the plate-end sliding cover body 1231 slides to the plate-end sliding cover closed joining passage position P2, the plate-end sliding cover body 1231 enters the plate-end core joining passage 1222. At this time, the plate-end sliding cover body 1231 can prevent the cable-end connector 11 from entering or leaving the plate-end core joining space 1223 through the plate-end core joining passage 1222. This effectively prevents the cable-end connector 11 from easily detaching from the plate-end insulation core 122. In this way, the present application can effectively prevent the miniaturized connector assembly from comprising the cable-end connector easily detach from the mated plate-end connector when subjected to external impact in electronic products, ensuring that the signal transmission effect of the connector assembly meets expectations.

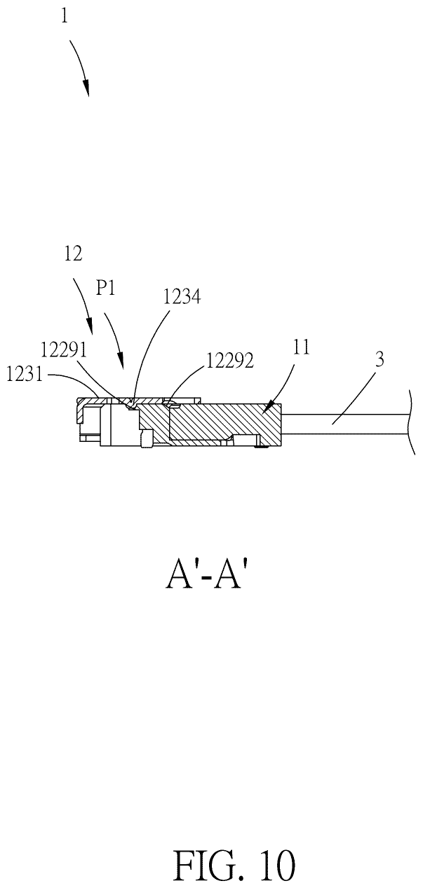

In the embodiment shown in FIG. 10, the plate-end sliding cover positioning structure 1234 can engage with the plate-end core closed joining passage positioning structure 12292, thereby positioning the plate-end sliding cover body 1231 at the plate-end sliding cover closed joining passage position P2. This effectively prevents the plate-end sliding cover body 1231 from easily leaving the plate-end sliding cover closed joining passage position P2. Additionally, the plate-end sliding cover positioning structure 1234 can abut the cable-end connector 11 (or the cable-end insulation core 112), preventing the cable-end connector 11 (or the cable-end insulation core 112) from leaving the plate-end core joining space 1223 through the plate-end core joining passage 1222. This effectively prevents the cable-end connector 11 from easily detaching from the plate-end insulation core 122.

In the above embodiment, when the plate-end sliding cover body 1231 slides to the plate-end sliding cover closed joining passage position P2, the plate-end sliding cover 123 can abut the plate-end core closed joining passage wall 1226 at the plate-end core sliding slot closed joining passage end E2. This prevents the plate-end sliding cover guiding structure 1232 from leaving the plate-end core sliding slot 1224, effectively preventing the plate-end sliding cover 123 from easily detaching from the plate-end insulation core 122.

It should be noted that the plate-end sliding cover 123 can optionally be made of a metallic material, providing shielding for the joining between the cable-end connector 11 and the plate-end connector 12, thereby ensuring that the signal transmission performance of the connector assembly 1 meets expectations.

It should be explained that the connector assembly provided by the present application, along with plate-end connector and cable-end connector thereof, can omit some of the aforementioned features. For example, in the present application, the plate-end connector comprises a plate-end conductive terminal, a plate-end insulation core, and a plate-end sliding cover. The plate-end conductive terminal comprises a plate-end terminal joining structure. The plate-end insulation core comprises a plate-end core joining guiding structure, a plate-end core joining passage, a plate-end core joining space, a plate-end core sliding slot, and a plate-end core open joining passage wall. The plate-end insulation core can engage with the plate-end conductive terminal, positioning the plate-end terminal joining structure in the plate-end core joining space. The two ends of the plate-end core sliding slot are defined as a plate-end core sliding slot open joining passage end and a plate-end core sliding slot closed joining passage end. The plate-end core open joining passage wall is adjacent to the plate-end core sliding slot open joining passage end, and the plate-end core joining passage extends to the plate-end core joining space. The plate-end sliding cover comprises a plate-end sliding cover body and a plate-end sliding cover guiding structure. The plate-end sliding cover guiding structure is configured to enter the plate-end core sliding slot, allowing the plate-end sliding cover guiding structure to be guided by the plate-end core sliding slot to slide to the plate-end core sliding slot open joining passage end or the plate-end core sliding slot closed joining passage end. This enables the plate-end sliding cover body to slide relative to the plate-end insulation core to a plate-end sliding cover open joining passage position or a plate-end sliding cover closed joining passage position. When the plate-end sliding cover body slides to the plate-end sliding cover open joining passage position, the plate-end sliding cover body leaves the plate-end core joining passage to open the plate-end core joining passage. This allows the plate-end core joining guiding structure to guide the cable-end connector through the plate-end core joining passage into the plate-end core joining space to join the plate-end terminal joining structure. Furthermore, the plate-end sliding cover guiding structure can abut the plate-end core open joining passage wall at the plate-end core sliding slot open joining passage end, preventing the plate-end sliding cover guiding structure from leaving the plate-end core sliding slot. When the plate-end sliding cover body slides to the plate-end sliding cover closed joining passage position, the plate-end sliding cover body enters the plate-end core joining passage, preventing the cable-end connector from entering or leaving the plate-end core joining space through the plate-end core joining passage.

Additionally, in the present application, the cable-end connector comprises a cable-end insulation core and a cable-end conductive terminal. The two sides of the cable-end insulation core are respectively defined as the cable-end core plate-end side and the cable-end core sliding cover side. The cable-end insulation core comprises a cable-end core joining guiding structure, a cable-end core joining passage, a cable-end core joining space, a cable-end core configuration structure, a cable-end core wiring space, and a cable-end core sliding guiding structure. Among them, the cable-end core wiring space, the cable-end core joining guiding structure, the cable-end core joining passage, the cable-end core joining space, and the cable-end core sliding guiding structure are positioned on the cable-end core plate-end side, while the cable-end core sliding guiding structure is positioned on the cable-end core sliding cover side. Additionally, the cable-end core joining passage extends to the cable-end core joining space. The cable-end conductive terminal comprises a plurality of cable-end terminal joining structures, a cable-end terminal configuration structure, and a cable-end terminal wiring structure. Specifically, the cable-end terminal wiring structure is configured to provide electrical connection to the conductive cable material. The cable-end terminal configuration structure can engage with the cable-end core configuration structure to assemble the cable-end conductive terminal into the cable-end insulation core, positioning the cable-end terminal wiring structure in the cable-end core wiring space and the plurality of cable-end terminal joining structures in the cable-end core joining space. The cable-end core joining guiding structure is configured to guide the plate-end terminal joining structure through the cable-end core joining passage into the plate-end core joining space to respectively mate with the plurality of cable-end terminal joining structures. The positions of the plurality of cable-end terminal joining structures are different, enabling the cable-end conductive terminal to join the plate-end terminal joining structure at multiple positions. Moreover, the cable-end core sliding guiding structure is capable of guiding the plate-end sliding cover body to slide relative to the plate-end insulation core.

Furthermore, in the present application, the connector assembly comprises a cable-end connector and a plate-end connector. The cable-end connector comprises a cable-end conductive terminal and a cable-end insulation core. The cable-end conductive terminal comprises a plurality of cable-end terminal joining structures. The cable-end insulation core comprises a cable-end core joining guiding structure, a cable-end core joining passage, and a cable-end core joining space. The cable-end insulation core can be assembled with the cable-end conductive terminal, positioning the plurality of cable-end terminal joining structures within the cable-end core joining space. Additionally, the cable-end core joining passage extends to the cable-end core joining space. The plate-end connector comprises a plate-end conductive terminal, a plate-end insulation core, and a plate-end sliding cover. The plate-end conductive terminal comprises a plate-end terminal joining structure. The plate-end insulation core comprises a plate-end core joining guiding structure, a plate-end core joining passage, a plate-end core joining space, a plate-end core sliding slot, and a plate-end core open joining passage wall. The plate-end insulation core can engage with the plate-end conductive terminal, positioning the plate-end terminal joining structure in the plate-end core joining space. The two ends of the plate-end core sliding slot are defined as a plate-end core sliding slot open joining passage end and a plate-end core sliding slot closed joining passage end. The plate-end core open joining passage wall is adjacent to the plate-end core sliding slot open joining passage end, and the plate-end core joining passage extends to the plate-end core joining space. The plate-end sliding cover comprises a plate-end sliding cover body and a plate-end sliding cover guiding structure. The plate-end sliding cover guiding structure can enter the plate-end core sliding slot, allowing it to be guided by the plate-end core sliding slot to slide to the plate-end core sliding slot open joining passage end or the plate-end core sliding slot closed joining passage end. This enables the plate-end sliding cover body to slide relative to the plate-end insulation core to a plate-end sliding cover open joining passage position or a plate-end sliding cover closed joining passage position. When the plate-end sliding cover body slides to the plate-end sliding cover open joining passage position, it leaves the plate-end core joining passage, opening the plate-end core joining passage. This allows the plate-end core joining guiding structure to guide the cable-end connector through the plate-end core joining passage into the plate-end core joining space. Moreover, the cable-end core joining guiding structure can guide the plate-end terminal joining structure through the cable-end core joining passage into the plate-end core joining space to respectively mate with the plurality of cable-end terminal joining structures. Due to the different positions of the plurality of cable-end terminal joining structures, the cable-end conductive terminal can join the plate-end terminal joining structure at multiple positions. Furthermore, the plate-end sliding cover guiding structure can abut the plate-end core open joining passage wall at the plate-end core sliding slot open joining passage end, preventing the plate-end sliding cover guiding structure from leaving the plate-end core sliding slot. When the plate-end sliding cover body slides to the plate-end sliding cover closed joining passage position, it enters the plate-end core joining passage, preventing the cable-end connector from entering or leaving the plate-end core joining space through the plate-end core joining passage.

In summary, the present application provides a miniaturizable connector assembly and plate-end connector and cable-end connector thereof. The cable-end connector is configured to mate with the plate-end connector. The plate-end connector comprises a plate-end insulation core and a plate-end sliding cover. The plate-end insulation core comprises a plate-end core joining space, and the cable-end connector can enter this plate-end core joining space to mate with the plate-end connector. The plate-end sliding cover is capable of preventing the cable-end connector from leaving the plate-end core joining space. This design effectively prevents the miniaturized connector assembly from comprising the cable-end connector easily detach from the mated plate-end connector when used in electronic products and subjected to external impact, ensuring that the signal transmission performance of the connector assembly meets expectations.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A plate-end connector configured to engage with a cable-end connector, the plate-end connector comprising:
a plate-end conductive terminal comprising a plate-end terminal joining structure;
a plate-end insulation core comprising a plate-end core joining guiding structure, a plate-end core joining passage, a plat e-end core joining space, a plate-end core sliding slot, and a plate-end core open joining passage wall, wherein, the plate-end insulation core is configured to mate with the plate-end conductive terminal to position the plate-end terminal joining structure within the plate-end core joining space; two ends of the plate-end core sliding slot respectively comprise a plate-end core sliding slot open joining passage end and a plate-end core sliding slot closed joining passage end; the plate-end core open joining passage wall is adjacent to the plate-end core sliding slot open joining passage end; and the plate-end core joining passage is extended to the plate-end core joining space; and
comprising a plate-end sliding cover body and a plate-end sliding cover guiding structure, wherein the plate-end sliding cover guiding structure is configured to enter the plate-end core sliding slot and to be guided by the plate-end core sliding slot to slide to the plate-end core sliding slot open joining passage end or the plate-end core sliding slot closed joining passage end, so as to allow the plate-end sliding cover body to slide relative to the plate-end insulation core to a plate-end sliding cover open joining passage position or a plate-end sliding cover closed joining passage position, wherein, when the plate-end sliding cover body slides to the plate-end sliding cover open joining passage position, the plate-end sliding cover body leaves the plate-end core joining passage to open the plate-end core joining passage, allowing the plate-end core joining guiding structure to guide the cable-end connector through the plate-end core joining passage into the plate-end core joining space to be joined with the plate-end terminal joining structure, and the plate-end sliding cover guiding structure abuts the plate-end core open joining passage wall at the plate-end core sliding slot open joining passage end, such that the plate-end sliding cover guiding structure is prevented from leaving the plate-end core sliding slot by the plate-end core open joining passage wall; and wherein, when the plate-end sliding cover body slides to the plate-end sliding cover closed joining passage position, the plate-end sliding cover body enters the plate-end core joining passage, thereby preventing the cable-end connector from entering or leaving the plate-end core joining space through the plate-end core joining passage.

2. The plate-end connector of claim 1, wherein the plate-end insulation core further comprises a plate-end core closed joining passage wall adjacent to the plate-end core sliding slot closed joining passage end, wherein, when the plate-end sliding cover body slides to the plate-end sliding cover closed joining passage position, the plate-end sliding cover is allowed to abut the plate-end core closed joining passage wall at the plate-end core sliding slot closed joining passage end, such that the plate-end sliding cover guiding structure is prevented from leaving the plate-end core sliding slot by the plate-end core closed joining passage wall.

3. The plate-end connector of claim 1, wherein the plate-end sliding cover further comprises a plate-end sliding cover guiding elastic arm connected to the plate-end sliding cover guiding structure, and the plate-end sliding cover guiding elastic arm is elastically deformable to allow the plate-end sliding cover guiding structure to enter the plate-end core sliding slot.

4. The plate-end connector of claim 1, wherein the plate-end insulation core further comprises a plate-end core interference guiding structure and a plate-end core joining interference structure, which are positioned in the plate-end core joining passage, wherein, when the cable-end connector is joined with the plate-end terminal joining structure, the plate-end core interference guiding structure guides the plate-end core joining interference structure to interfere with the cable-end connector, thereby preventing the cable-end connector from leaving the plate-end core joining space through the plate-end core joining passage.

5. The plate-end connector of claim 4, wherein the plate-end core interference guiding structure and the plate-end core joining interference structure are connectable to form a hook-shaped structure.

6. The plate-end connector of claim 1, wherein the plate-end insulation core further comprises a plate-end core open joining passage positioning structure, and the plate-end sliding cover further comprises a plate-end sliding cover positioning structure configured to engage with the plate-end core open joining passage positioning structure so as to position the plate-end sliding cover body at the plate-end sliding cover open joining passage position.

7. The plate-end connector of claim 6, wherein the plate-end insulation core further comprises a plate-end core closed joining passage positioning structure configured to engage with the plate-end sliding cover positioning structure so as to position the plate-end sliding cover body at the plate-end sliding cover closed joining passage position.

8. The plate-end connector of claim 6, wherein when the plate-end sliding cover body slides to the plate-end sliding cover closed joining passage position, the plate-end sliding cover positioning structure abuts the cable-end connector, thereby preventing the cable-end connector from entering or leaving the plate-end core joining space through the plate-end core joining passage.

9. A cable-end connector configured to engage with a conductive cable material and the plate-end connector of claim 1, the cable-end connector comprising:
a cable-end insulation core comprising a cable-end core plate-end side and a cable-end core sliding cover side respectively at two sides thereof; the cable-end insulation core comprising a cable-end core joining guiding structure, a cable-end core joining passage, a cable-end core joining space, a cable-end core configuration structure, a cable-end core wiring space, and a cable-end core sliding guiding structure, wherein, the cable-end core wiring space, the cable-end core joining guiding structure, the cable-end core joining passage, the cable-end core joining space, and the cable-end core sliding guiding structure are positioned on the cable-end core plate-end side; the cable-end core sliding guiding structure is positioned on the cable-end core sliding cover side; and the cable-end core joining passage is extended to the cable-end core joining space; and
a cable-end conductive terminal comprising a plurality of cable-end terminal joining structures, a cable-end terminal configuration structure, and a cable-end terminal wiring structure; wherein,
the cable-end terminal wiring structure is configured to provide electrical connection to the conductive cable material; the cable-end terminal configuration structure is configured to engage with the cable-end core configuration structure, so as to assemble the cable-end conductive terminal in the cable-end insulation core and position the cable-end terminal wiring structure and the plurality of cable-end terminal joining structures respectively in the cable-end core wiring space and in the cable-end core joining space;
the cable-end core joining guiding structure is configured to guide the plate-end terminal joining structure through the cable-end core joining passage into the cable-end core joining space to be joined with the plurality of cable-end terminal joining structures respectively;
the plurality of cable-end terminal joining structures are located at different positions, allowing the cable-end conductive terminal to be joined with the plate-end terminal joining structure at multiple positions; and
the cable-end core sliding guiding structure is configured to guide the plate-end sliding cover body to slide relative to the plate-end insulation core.

10. The cable-end connector of claim 9, wherein the cable-end insulation core is embedded in the plate-end insulation core, such that the cable-end core sliding guiding structure is positioned below the plate-end sliding cover body, thereby preventing the cable-end insulation core from interfering with the sliding of the plate-end sliding cover body.

11. The cable-end connector of claim 9, wherein the cable-end insulation core comprises a cable-end core sliding surface located at the cable-end core sliding cover side, and the cable-end core sliding guiding structure is positioned on the cable-end core sliding surface.

12. The cable-end connector of claim 9, wherein when the plate-end sliding cover body slides to the plate-end sliding cover closed joining passage position, the plate-end sliding cover abuts the cable-end insulation core, thereby preventing the cable-end insulation core from leaving the plate-end core joining space through the plate-end core joining passage.

13. The cable-end connector of claim 9, wherein the cable-end insulation core further comprises a cable-end core interference guiding structure and a cable-end core joining interference structure, and when the plate-end terminal joining structure is joined with the plurality of cable-end terminal joining structures respectively, the cable-end core interference guiding structure guides the cable-end core joining interference structure to interfere with the plate-end insulation core, thereby preventing the cable-end insulation core from leaving the plate-end core joining space through the plate-end core joining passage.

14. The cable-end connector of claim 13, wherein the cable-end core interference guiding structure and the cable-end core joining interference structure are connectable to form a hook-shaped structure.

15. A connector assembly comprising:
a cable-end connector comprising:
a cable-end conductive terminal comprising a plurality of cable-end terminal joining structures; and
a cable-end insulation core comprising a cable-end core joining guiding structure, a cable-end core joining passage, and a cable-end core joining space, wherein the cable-end insulation core is configured to assemble with the cable-end conductive terminal to position the plurality of terminal joining structures within the core joining space; and the cable-end core joining passage is extended to the cable-end core joining space; and
a plate-end connector comprising:
a plate-end conductive terminal comprising a plate-end terminal joining structure;
a plate-end insulation core comprising a plate-end core joining guiding structure, a plate-end core joining passage, a plate-end core joining space, a plate-end core sliding slot, and a plate-end core open joining passage wall, wherein, the plate-end insulation core is configured to mate with the plate-end conductive terminal to position the plate-end terminal joining structure in the plate-end core joining space; two ends of the plate-end core sliding slot respectively comprises a plate-end core sliding slot open joining passage end and a plate-end core sliding slot closed joining passage end; the plate-end core open joining passage wall is adjacent to the plate-end core sliding slot open joining passage end; and the plate-end core joining passage is extended to the plate-end core joining space; and
comprising a plate-end sliding cover body and a plate-end sliding cover guiding structure, wherein the plate-end sliding cover guiding structure is configured to enter the plate-end core sliding slot and to be guided by the plate-end core sliding slot to slide to the plate-end core sliding slot open joining passage end or the plate-end core sliding slot closed joining passage end, so as to allow the plate-end sliding cover body to slide relative to the plate-end insulation core to a plate-end sliding cover open joining passage position or a plate-end sliding cover closed joining passage position; wherein,
when the plate-end sliding cover body slides to the plate-end sliding cover open joining passage position, the plate-end sliding cover body leaves the plate-end core joining passage to open the plate-end core joining passage, allowing the plate-end core joining guiding structure to guide the cable-end connector through the plate-end core joining passage into the plate-end core joining space, and the cable-end core joining guiding structure guides the plate-end terminal joining structure through the cable-end core joining passage into the cable-end core joining space to be joined with the plurality of cable-end terminal joining structures respectively; the plurality of cable-end terminal joining structures are located at different positions, allowing the cable-end conductive terminal to be joined with the plate-end terminal joining structure at multiple positions; and the plate-end sliding cover guiding structure is configured to abut the plate-end core open joining passage wall at the plate-end core sliding slot open joining passage end, such that the plate-end sliding cover guiding structure is prevented from leaving the plate-end core sliding slot by the plate-end core open joining passage wall; and
when the plate-end sliding cover body slides to the plate-end sliding cover closed joining passage position, the plate-end sliding cover body enters the plate-end core joining passage, thereby preventing the cable-end connector from entering or leaving the plate-end core joining space through the plate-end core joining passage.
